(19) United States
(12) Patent Application Publication
(10) Pub. No.: US 2023/0401184 A1
(43) Pub. Date: Dec. 14, 2023

(54) INFORMATION VALIDATION APPLICATION

(71) Applicant: NIBIN PHILIP, MISSOURI CITY, TX (US)

(72) Inventor: NIBIN PHILIP, MISSOURI CITY, TX (US)

(21) Appl. No.: 17/836,754

(22) Filed: Jun. 9, 2022

(51) Int. Cl. G06F 16/215; G06F 16/23

(52) U.S. Cl. CPC G06F 16/215; G06F 16/2365

(57) ABSTRACT

An information validation system application includes one or more electronic devices in communication with the internet configured to assess and validate the accuracy of information. The system is configured to associate content with blockchain technology to track changes and source of changes in content. The system will use content creators and users to take part in validating information to ensure and enhance accuracy of the information on the internet. A voting process may be used to validate data in accordance with a truth engine algorithm or through proper documentation.

### BACKGROUND OF THE INVENTION

### 1. Field of the Invention

The present application relates to a system, a computer implemented method, and more particularly to a system configured to effectively validate and enhance quality data on the internet.

### 2. Description of Related Art

As of 2021, there were over 4 billion internet users and it is projected to see a steady rise in the numbers as each day passes by. The Internet is the gold mine of data and every user spends hours each day searching for information on a wide range of topics. The data found may be used for various purposes from writing a school essay to building a drone. Eventually, there is new data created, some stored, transferred, or even manipulated. It is this data that controls what we believe.

Enormous chunks of data are generated every second globally and the way the data is extracted, transported, saved, and communicated is always prone to a high level of manipulations and tampering. It is this manipulation of data, masking of truth, and overall tampering that is a big issue with the internet data. The conventional way of voting by users was never significantly effective in maintaining the quality of validations. This resulted in lies, or at best brief opinions, being portrayed as the truth leaving the manipulated data to persist for further engineering and processing. This ultimately leads to completely inaccurate results and conclusions.

Although strides have been made with data collection and dissemination, shortcomings remain. It is desired that a system be provided that assists to filter out inaccurate information and provides a suitable validation method to ensure quality data being enhanced on the internet.

### BRIEF SUMMARY OF THE INVENTION

It is an object of the present application to provide a system intended to enhance the quality of data on the Internet with the aim of providing content that is true and can be trusted. The content quality is determined by certain conditions or vectors that deem it true. The quality of any data is directly proportional to the authenticity, reliability, and truthfulness of the data and its sources.

The system is further configured to develop a truth ecosystem where the content is effectively validated with genuine citations and data backing. This tamper-proof decentralized ecosystem makes and keeps the validated contents accessible to the users with sufficient proof. Ultimately with an abundance of Validated data, users may benefit from maximum qualified data ruling out chances of confusion and erroneous understanding.

It is a further object of the present application that the system operate through one or more networks through the world wide web to ensure existing data previously captured and additional new data is adequately validated and disseminated for the general public. Additionally, the system is operable under at least a singular platform or site for access by any user.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a diagram of an information validation system application according to an embodiment of the present application.

FIG. 2 is a diagram of an exemplary electronic device used in the information validation system application of FIG. 1.

FIG. 3 is a chart of the content validation steps used in the information validation system application of FIG. 1.

FIG. 4 is a chart of sources considered repudiable in the information validation system application of FIG. 1.

FIG. 5 is a chart of the decision tree that the information validation system application of FIG. 1 uses to assess content.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, the information validation system application of the present application is configured to enhance the quality of data on the Internet with the aim of providing content that is true and can be trusted. In the system of the present application, the content quality is determined by certain conditions or vectors that deem it true. The quality of any data is directly proportional to the authenticity, reliability, and truthfulness of the data and its sources.

The system of the present application is developing a truth ecosystem where the content is effectively validated with genuine citations and data backing. This tamper-proof decentralized ecosystem makes and keeps the validated contents accessible to the users with sufficient proof. And ultimately with an abundance of Validated data, users receive maximum qualified data thereby ruling out chances of confusion and erroneous understanding. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

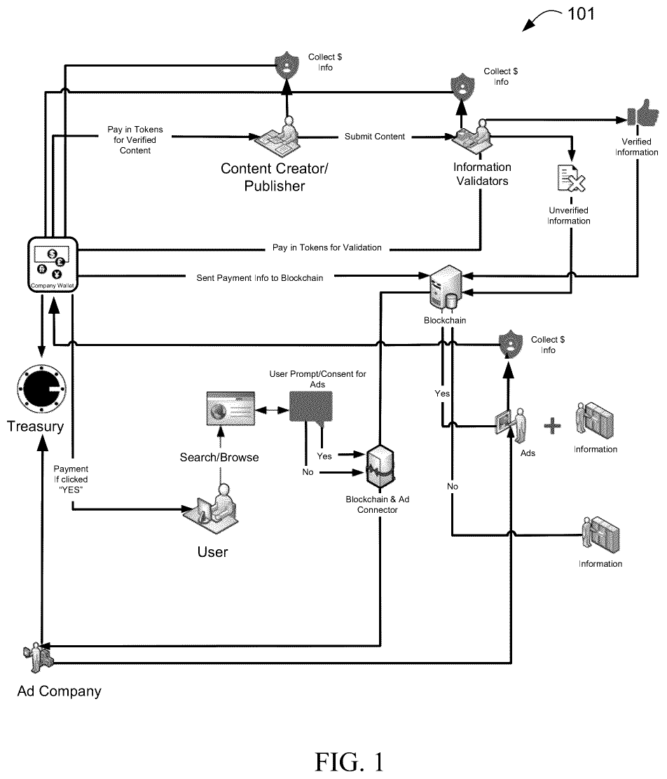

Referring now to FIG. 1 in the drawings, a diagram of an information validation system application 101 is provided. As noted previously, system 101 is configured to validate information on the internet and becomes a singular source of authenticity to data collected and stored. Data quality will be increased through a rigorous validation process requiring validation of sources and in some cases public voting. Such information may be provided to the public on one or more platforms over a network, such as the world wide web.

System 101 relies upon a plurality of community members to publish, validate, review, and create information for viewing. A goal of the present system 101 is to provide an increased level of accuracy of information displayed on the internet that can be validated as opposed to what is commonly seen. Validation and accuracy is what will set apart system 101 from those of other general community sites or publications.

System 101 will rely upon two main active community members. First community member is that of a publisher or contributor. System 101 invites these content creators to the platform and expects them to create quality content or validate existing content with sufficient data backing and related works or both. These content creators are a crucial role aimed toward making the community stronger. Publishers will be competitively awarded for their efforts in building a reliable community framework and ecosystem on the platform.

The second group of community members is that of a user. Users are the general internet users who visit system 101 to access the published content for various purposes. Users get to choose from promotional content viewing or elect not to. They get rewarded in cryptographic tokens for their activities which remain untracked and privacy assured. This helps the Users in mainly two ways: (1) where they have access to the finest data at all times and (2) the rewards they keep receiving over their activities by never compromising on privacy.

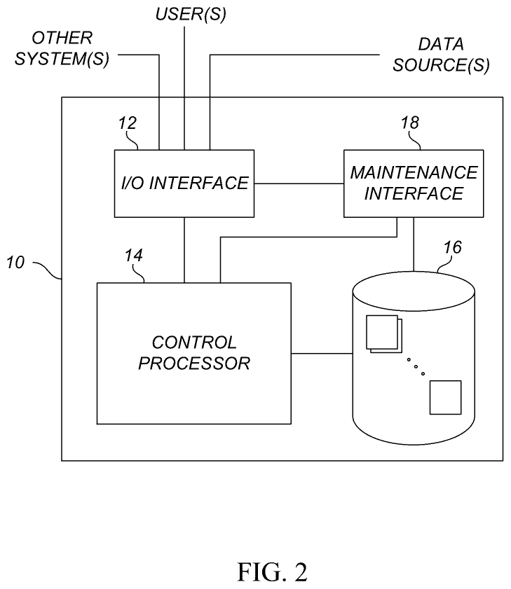

Referring now also to FIG. 2 in the drawings, a schematic of an exemplary electronic device used in system 101 is illustrated. As seen in FIG. 1, system 101 uses one or more electronic device in its operation. The devices may include servers, databases, processors, and so forth for the collection, storage, analysis, validation and dissemination of data. Any one of the devices in FIG. 1 may be represented herein by exemplary electronic device 10 of FIG. 2.

FIG. 2 illustrates an exemplary electronic device 10 for evaluating and assessing information, communicating between users and entities, and for rewarding such users or publishers for participation. The information evaluated may be related to any product, organization, individual, or other identifiable event.

The electronic device 10 includes an input/output (I/O) interface 12, a control processor 14, a database 16, and a maintenance interface 18. Alternative embodiments can combine or distribute the input/output (I/O) interface 12, control processor 14, database 16, and maintenance interface 18 as desired. Embodiments of the electronic device 10 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore, the computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the electronic device 10. The I/O interface 12 can be configured for allowing one or more users to input information to the electronic device 10 via any known input device. Examples can include a keyboard, mouse, touch screen, microphone, and/or any other desired input device. The I/O interface 12 can be configured for allowing one or more users to receive information output from the electronic device 10 via any known output device. Examples can include a display monitor, a printer, a speaker, and/or any other desired output device. The I/O interface 12 can be configured for allowing other systems to communicate with the electronic device 10. For example, the I/O interface 12 can allow one or more remote computer(s) to access information, input information, and/or remotely instruct the electronic device 10 to perform one or more of the tasks described herein. The I/O interface 12 can be configured for allowing communication with one or more remote data sources. For example, the I/O interface 12 can allow one or more remote data source(s) to access information, input information, and/or remotely instruct the electronic device 10 to perform one or more of the tasks described herein.

The database 16 provides persistent data storage for electronic device 10. While the term “database” is primarily used, a memory or other suitable data storage arrangement may provide the functionality of the database 16. In alternative embodiments, the database 16 can be integral to or separate from the electronic device 10 and can operate on one or more computers. The database 16 preferably provides non-volatile data storage for any information suitable to support the operation of the electronic device 10.

The maintenance interface 18 is configured to allow users to maintain desired operation of the electronic device 10. In some embodiments, the maintenance interface 18 can be configured to allow for reviewing and/or revising the data stored in the database 16 and/or performing any suitable administrative tasks commonly associated with database management. This can include, for example, updating database management software, revising security settings, and/or performing data backup operations. In some embodiments, the maintenance interface 18 can be configured to allow for maintenance of the control processor 14 and/or the I/O interface 12. This can include, for example, software updates and/or administrative tasks such as security management and/or adjustment of certain tolerance settings.

The control processor 14 is configured to follow defined procedures for assessing and validating information along with tracking any and all rewards and user interactions according to concepts disclosed herein. The control processor 14 can include various combinations of one or more processors, memories, and software components.

Referring back to FIG. 1 in the drawings, a user 103 may use the electronic device to access the internet wherein they may be prompted to accept of reject the use of Ads. If Ads are accepted, the user may obtain rewards that are tracked through a treasury into an online account. The user may then view and take part in any validation actions available to which he/she may have input for.

Ad data is collected and monitored. Monetization may be enabled to allow for the collection of revenue and its sharing with users and/or publishers through a reward program. The reward program may be tracked via a Treasury and stored within an account as noted above.

Content creators, namely publishers and contributors, create content and/or validate content to which they may be rewarded through the reward program. Data created or reviewed may be submitted to information validators to be assessed in quality prior to or upon uploading to the public. Both the verified and unverified information is routed through blockchain technology for tracking. The metadata of the information that is submitted by the content publishers or contributors are saved on the blockchain to ensure integrity and visibility of the information. Any tampering of the information can be tracked and visible to the users. Data itself is stored on decentralized machines around the world.

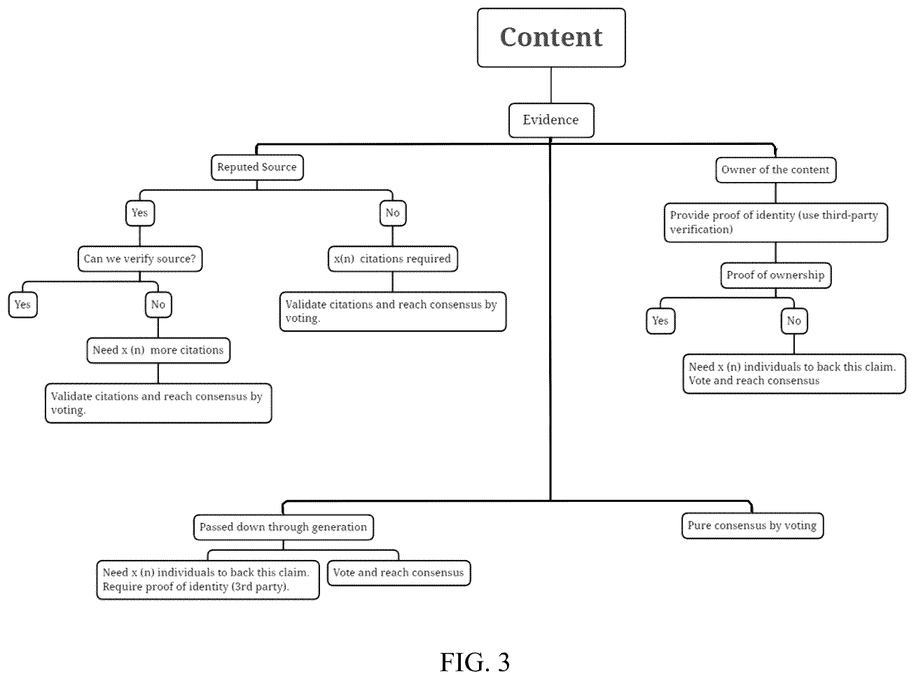

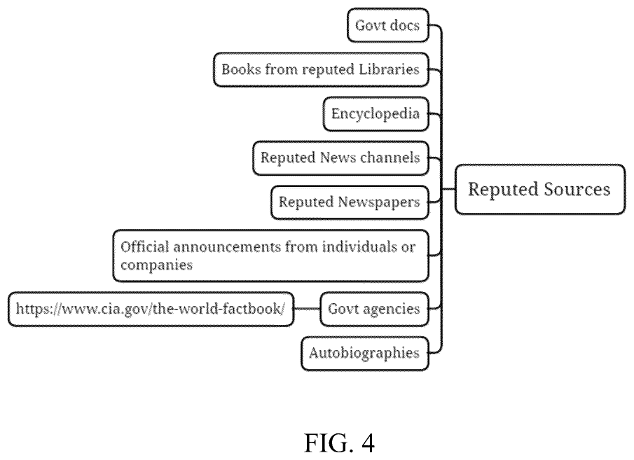

Referring now also to FIGS. 3 and 4 in the drawings, charts of the content validation steps and reputed sources used in system 101 is illustrated. To validate information on the system, evidence is provided and assessed as to its strength and likelihood of accuracy so as to give credence to its truthfulness. Four main areas may be used to assess data in system 101 for verification purposes. Reputed sources may be used. These are sources that are generally thought to be honest, non-biased, and relatively mainstream in acceptance as an authoritarian with respect to information. As seen, examples may include government documents and agencies, books from repudiable libraries, encyclopedias, news outlets, official announcements, and even autobiographies. It is desired that the source being attributed to the information be verifiable.

Another source may be owners of the content itself. This may be people to which the events happened to or were involved. This may also be those that observed and documented an occurrence. Proof of ownership is desired.

Another source may be information that has passed down through generations. Information that is fairly accepted over time and without much variation are ideal. Proof of identity of any third-party may be required as it would be preferred that an individual be available to back the information. Lastly, information may be validated through pure consensus by a voting of content creators and/or users.

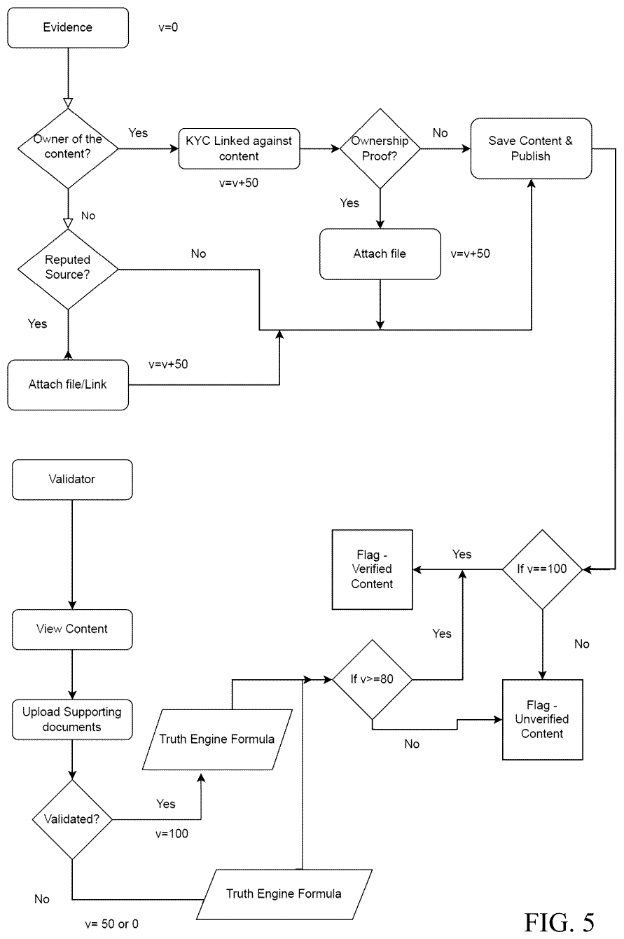

Referring now also to FIG. 5 in the drawings, a chart of the decision tree that content in system 101 must be weighed by is provided. Evidence is assess in two different routes depending on the type of evidence submitted. First, system 101 assesses or validates the truthfulness of the content based on if the owner of the content can be substantiated. If it is submitted via the owner, system 101 looks to validate the owner through KYC processes (“know your client”). If proof of ownership can be obtained then documentation is attached to the file. The content can be saved and published. If the owner of the content is not verified, then system 101 looks to assess if it came from a repudiable source. If so, sufficient documentation is attached to the file substantiating the repudiable source and the content is saved and published.

At each step in the process of evaluating the evidence, a validation score may be generated. With the upper portion of FIG. 5, evidence is provided scores of 0, 50, and 100. When partially validated information is passed through the system, v is assigned a value of 50. When information passes the validation requirements, v is assigned a value of 100 and when an information is not able to pass the validation requirements, v is assigned a value of 0. With the upper section of FIG. 5, the evidence is provided through potentially an owner of the content or through a repudiable source. The level of verification or validation increases the score. If that information is validated, the score of 100 is issued. If the validation score is 100 then it is flagged verified. If it is not 100 then it is flagged unverified but still published. The validation score is then used to determine whether the content is flagged verified or unverified.

The act of voting by one or more validators may be used to validate content as seen with the lower portion of FIG. 5. An option called consensus verified will be available and this is achieved by voting. Wherein existing content is viewed and assessed, system 101 may handle such information differently. In such situation, the owner may be unknown or even the source of the information can't be attributed to a repudiable source. A validator user can view the content and upload supporting documents that act to validate the content. Validators will then be allowed to vote whether the information is verifiable. KYC will be completed for the users to avoid spammers. In this option, publishers and users can participate. Each validator can select the option of v=‘true’ or ‘false’ and the option that gets the highest vote will be used to finalize consensus verified information. A yes vote means v=100. A no vote means v=50 or 0

The truth engine algorithm may be used with all types of evidence as seen with FIG. 5. The truth engine algorithm is shown as:

$$T = \frac{v 1 + v 2 + v 3 + … Vn}{2}$$

$$T = Truth value$$

$$v = validated value ( 0 , 50 or 100 )$$

The information is passed through the truth engine algorithm to determine whether validated or not. A validation score is created based upon votes. A truth value limit is assigned as the cutoff line between verified and non verified. The truth value limit is adjustable if desired. In the present case, a value of T=80 is used as the limit. This score is assigned by system 101 automatically and system 101 then will automatically flag the content as verified or not verified based upon the score.

The act of voting may be done primarily if and when the information fails to be attributed to any of the other 3 types of information as seen in FIG. 3. The act of voting may also be incorporated into any other assessment as seen in FIG. 3. This also may be done where ownership or verification of source cannot be provided.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A computer implemented method to enhance the quality of content on the world wide web, the method comprising:
generating content for viewing on the world wide web;
validating the content generated, the content being assigned a validation score;
associating the content and changes therewith with blockchain technology;
publishing the content on the world wide web; and
providing rewards for participation in a validation process.

2. The method of claim 1, wherein the act of validating content includes assessing ownership of the content.

3. The method of claim 2, further comprising:
collecting proof of ownership.

4. The method of claim 1, wherein the act of validating content includes identifying a source of the content.

5. The method of claim 1, further comprising:
attaching at least one of files and interactive links to sources for proof or validation.

6. The method of claim 1, wherein the act of validating content includes an act of voting.

7. The method of claim 6, wherein one or more validators vote if the content is verifiable, a vote of “yes” scores higher than a vote of “no”.

8. The method of claim 7, wherein the act of voting provides a truth value score.

9. The method of claim 8, wherein the content is marked as verifiable if the truth value score is higher than a truth value limit.

10. The method of claim 6, wherein voting is weighed in accordance with a truth engine algorithm.

11. The method of claim 10, wherein the truth algorithm is configured to assess a validation score to any content to be verified.

12. A computer implemented method to validate accuracy of content on the internet, the method comprising:
validating the content generated, the content being assigned a validation score;
assessing ownership of the content, wherein validation of ownership is provided through a third-party;
identifying the source of the content;
associating the content and changes therewith with blockchain technology; and
providing rewards for participation in a validation process.

13. The method of claim 12, wherein the act of validating content includes assessing ownership of the content.

14. The method of claim 12, wherein the act of validating content includes identifying a source of the content.

15. The method of claim 12, wherein the act of validating content includes an act of voting.

16. The method of claim 15, wherein one or more validators vote if the content is verifiable, a vote of “yes” scores higher than a vote of “no”.

17. The method of claim 16, wherein the act of voting provides a truth value score.

18. The method of claim 17, wherein the content is marked as verifiable if the truth value score is higher than a truth value limit.

19. The method of claim 15, wherein voting is weighed in accordance with a truth engine algorithm.
